(19) United States
(12) Patent Application Publication
(10) Pub. No.: US 2014/0125890 A1
(43) Pub. Date: May 8, 2014

(54) THREE-DIMENSIONAL GLASSES AND CONTROL CHIP THEREOF

(71) Applicant: BEIJING BOE OPTOELECTRONICS TECHNOLOGY CO., LTD., Beijing (CN)

(72) Inventors: Zhenyu Xie, Beijing (CN); Wenyu Zhang, Beijing (CN); Shaoying Xu, Beijing (CN); Tiansheng Li, Beijing (CN); Changjiang Yan, Beijing (CN)

(73) Assignee: BEIJING BOE OPTOELECTRONICS TECHNOLOGY CO., LTD., Beijing (CN)

(21) Appl. No.: 14/127,051

(22) PCT Filed: Feb. 26, 2013
(86) PCT No.: PCT/CN2013/071905

§ 371 Date: Dec. 17, 2013

(30) Foreign Application Priority Data
Feb. 27, 2012 (CN) 201220066887.0

(51) Int. Cl. G02B 27/22

(52) U.S. Cl. CPC G02B 27/2264
USPC 349/13

(57) ABSTRACT

Embodiments of the present invention provide three-dimensional glasses and a control chip thereof. The three-dimensional glasses comprise: a normal black mode liquid crystal eyeglass; a normal white mode liquid crystal eyeglass; and a control chip, connected to both of the normal black mode liquid crystal eyeglass and the normal white mode liquid crystal eyeglass, wherein a voltage output terminal of the control chip simultaneously supplies a high level or a low level to the normal black mode liquid crystal eyeglass and the normal white mode liquid crystal eyeglass based on a predetermined high and low level switching frequency.

### FIELD OF THE INVENTION

The embodiments of the present invention relate to a three-dimensional glasses and a control chip thereof.

### BACKGROUND OF THE INVENTION

The three-dimensional (3D) stereoscopic display has become a major trend in the display field as the technology evolves. A 3D image viewed by viewer's eyes is indeed a combined image from a left-eye image and a right-eye image having a parallax, wherein the left-eye image is seen only by a left eye of the viewer and the right-eye image is seen only by his right eye. The 3D image is thus presented due to the visual persistence of the viewer's eyes.

Typically, a three-dimensional glasses is required for viewing a 3D image, for the glasses type 3D display technology.

A shutter type 3D glasses is one kind of conventional 3D glasses, with a structure as shown in FIG. 1. The shutter type 3D glasses mainly comprises a glasses frame 11, a first and a second liquid crystal eyeglasses 12 in the same identical mode, a voltage control chip supplying levels to both of the liquid crystal eyeglasses, and a frequency transmitter. Herein, the liquid crystal eyeglass has a structure as shown in FIG. 2, comprising glass substrates 21, a liquid crystal molecule layer 22, upper and lower polarizers 23, and orientation films 24. Typically, the liquid crystal eyeglasses can operate in a normal black mode and a normal white mode, wherein the normal black mode refers to a mode in which light can not transmit through liquid crystal molecules in the liquid crystal eyeglass under a low level, thereby the light can not pass through the liquid crystal eyeglass, a 3D image can not be seen via the liquid crystal eyeglass; while the normal white mode refers to a mode in which light can transmit through liquid crystal molecules in the liquid crystal eyeglass under a low level, thereby the light can pass through the liquid crystal eyeglass, and allowing a 3D image from being seen via the liquid crystal eyeglass.

A current procedure of viewing a 3D image by using the shutter type 3D glasses is as follows.

A frequency transmitter transmits a signal to a voltage control chip at a frequency in synchronization with a refreshing frequency of a display viewed by a viewer, to control the voltage control chip for supplying a high level or a low level to the liquid crystal eyeglasses. By way of example, assuming both the first and second liquid crystal eyeglasses operate in the normal white mode, in the case of a refreshing frequency of 200 Hz for the display (that is, a displaying time for one image is 5 ms), the frequency transmitter transmits the signal to the voltage control chip at the timing of 5 ms by taking 0 ms as a beginning, and the voltage control chip supplies a high level to the first liquid crystal eyeglass upon receiving the signal, switching the first liquid crystal eyeglass to a light-blocking state, while the voltage control chip supplies a low level to the second liquid crystal eyeglass such that the second liquid crystal eyeglass is still in a light-transmitting state and allows light to pass; then, at the timing of 10 ms, the voltage control chip supplies a low level to the first liquid crystal eyeglass, switching it into the original normal white mode, and supplies a high level to the second liquid crystal eyeglass such that the second liquid crystal eyeglass is switched into a light-blocking state, and thus, at the same time, the viewer's eyes see the image only through one of the liquid crystal eyeglasses.

However, in the above mentioned glasses, the voltage control chip thereof is required to supply a low level and a high level at the same time, thereby requiring transmitting a large number of signals.

### SUMMARY

The embodiments of the present invention provide a 3D glasses capable of substantially decreasing the number of the signals required to be transmitted.

The present invention provides a 3D glasses, comprising: a normal black mode liquid crystal eyeglass; a normal white mode liquid crystal eyeglass; and a control chip, connected to both of the normal black mode liquid crystal eyeglass and the normal white mode liquid crystal eyeglass, wherein a voltage output terminal of the control chip simultaneously supplies a high level or a low level to the normal black mode liquid crystal eyeglass and the normal white mode liquid crystal eyeglass based on a predetermined high and low level switching frequency.

The pair of 3D glasses provided by the embodiments of the present invention comprises liquid crystal eyeglasses with different modes, such that the control chip only transmits one identical signal to both of the liquid crystal eyeglasses for controlling the mode switching of the two Liquid crystal eyeglasses. In such case, the number of the signals required to be transmitted is substantially decreased with the glasses in accordance with the embodiments of the present invention.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a perspective structural view of a shutter type 3D glasses in the prior art;

FIG. 2 is a cross-sectional view of a liquid crystal eyeglass in the prior art;

FIG. 3 is a perspective structural view of a 3D glasses in accordance with an embodiment of the present invention;

FIG. 4 is a internal structural view of a 3D glasses in accordance with an embodiment of the present invention;

FIG. 5 is a block diagram of a control chip in accordance with an embodiment of the present invention; and

FIG. 6 is a block diagram of another control chip in accordance with an embodiment of the present invention.

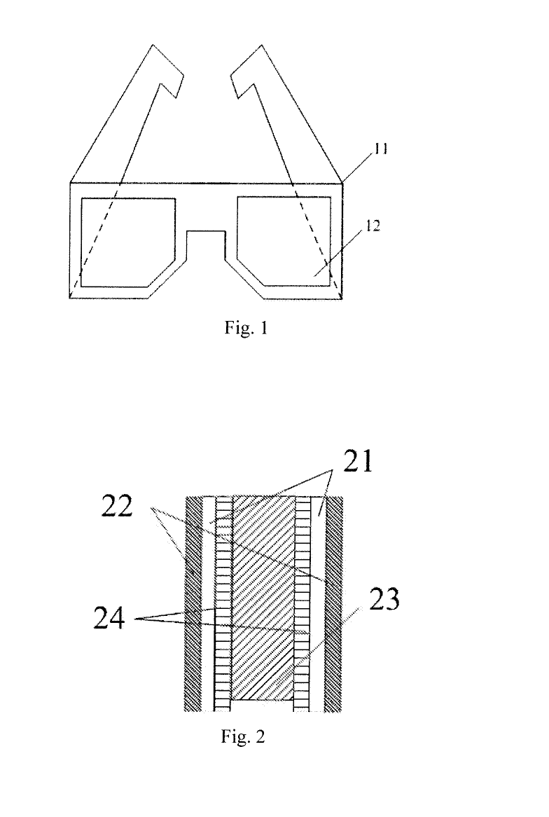

### DETAILED DESCRIPTION OF THE PREFERRED EMBODIMENTS

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

The embodiments of the present invention provides a 3D glasses comprising liquid crystal eyeglasses in different modes, such that the control chip is only required to transmit one same signal to both of the liquid crystal eyeglasses at the same time to control the mode switching of the two liquid crystal eyeglasses. Therefore, the 3D glasses in accordance with the embodiments of the present invention substantially decrease the number of the signals that needs to be transmitted.

A detailed description will be provided as below to explain a technical solution of the present invention.

### A First Embodiment

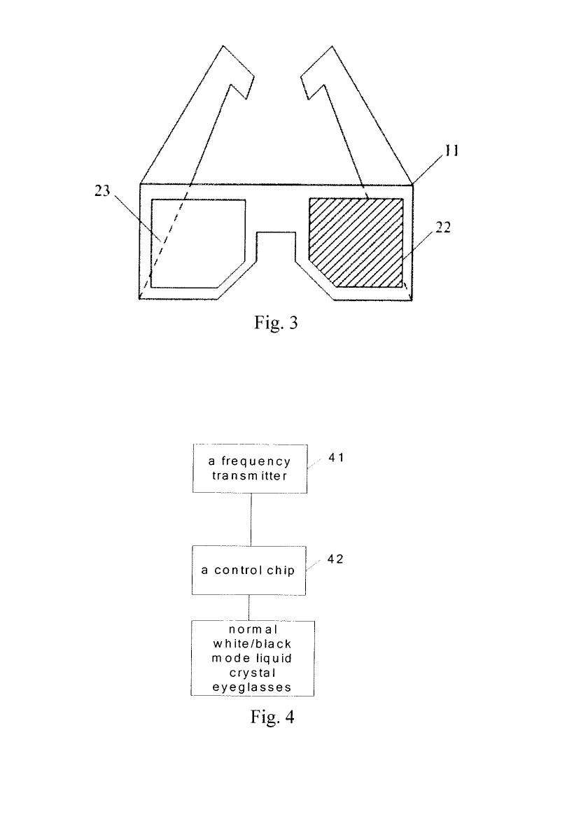

As shown in FIG. 3 and FIG. 4, a 3D glasses in accordance with the first embodiment comprises a glasses frame 11, a normal white mode liquid crystal eyeglass 23, a normal black mode liquid crystal eyeglass 22, a control chip 42 and a frequency transmitter 41. The control chip 42 is connected to the normal white mode liquid crystal eyeglass 23 and the normal black mode liquid crystal eyeglass 22, wherein a voltage output terminal of the control chip 42 simultaneously supplies a high level or a low level to the normal black mode liquid crystal eyeglass 22 and the normal white mode liquid crystal eyeglass 23 based on a predetermined switching frequency of high and low level. The frequency transmitter 41 transmits a signal to the control chip 42 based on a predetermined frequency, or after receiving a refreshing frequency from a liquid crystal display, transmits a signal to the control chip 42 based on the refreshing frequency.

As shown in FIG. 5, the control chip comprises a frequency receiving unit 51 and a voltage output unit 52. The frequency receiving unit 51 is used to receive the signal transmitted by the frequency transmitter 41, and transmits a control signal to the voltage output unit 52 for switching between high and low levels. The voltage output unit 52 supplies a high level or a low level to both of the normal white mode liquid crystal eyeglass 23 and the normal black mode liquid crystal eyeglass 22 concurrently through the voltage output terminal based on the control signal.

Alternatively, the frequency transmitted 41 may supply a frequency signal directly to the control chip 42, the frequency receiving unit 51 of the control chip 42 receives the frequency signal transmitted by the frequency transmitter 41 and transmits a control signal for switching between high and low levels to the voltage output unit 52 based on the frequency signal so that a high level or a low level is inputted into the normal white mode liquid crystal eyeglass 23 and the normal black mode liquid crystal eyeglass 22.

The embodiments of the present invention provide a 3D glasses comprising liquid crystal eyeglasses in different modes, such that the control chip is only required to transmit one same signal to both of the liquid crystal eyeglasses at the same time to control the mode switching of the two liquid crystal eyeglasses. Therefore, the 3D glasses in accordance with the embodiments of the present invention substantially decreases the number of the signals required to be transmitted.

### A Second Embodiment

In order to decrease the manufacturing cost of a 3D eyeglasses, the second embodiment of the present invention provides another 3D eyeglasses. As shown in FIG. 3, the 3D liquid crystal eyeglasses comprise a glasses frame 11, a normal white mode liquid crystal eyeglass 23, a normal black mode liquid crystal eyeglass 22, and a control chip. The control chip is connected to both of the normal black mode liquid crystal eyeglass and the normal white mode liquid crystal eyeglass, wherein a voltage output terminal of the control chip simultaneously supplies a high level or a low level to the normal black mode liquid crystal eyeglass 22 and the normal white mode liquid crystal eyeglass 23 based on a predetermined switching frequency of high and low level.

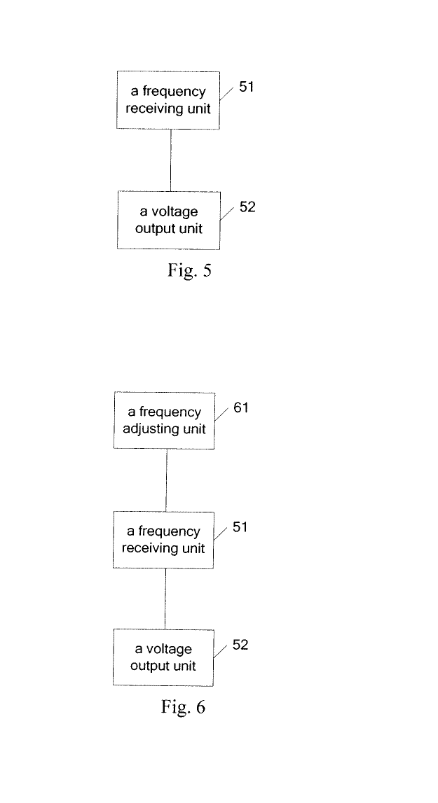

As shown in FIG. 6, the control chip comprises a frequency adjusting unit 61, a frequency receiving unit 51 and a voltage output unit 52. The frequency adjusting unit 61 is used to adjust a frequency thereof based on a predetermined frequency or a received refreshing frequency of a display, and generates and transmits a signal to the frequency receiving unit based on the adjusted frequency. The frequency receiving unit 51 is used to transmit a control signal for switching between high and low levels to the voltage output unit 52 based on the received signal. The voltage output unit 52 supplies a high level or a low level to both of the normal white mode liquid crystal eyeglass 23 and the normal black mode liquid crystal eyeglass 22 concurrently through the voltage output terminal based on the received control signal.

In the above embodiment, the normal black mode liquid crystal eyeglass is switched into a light-transmitting state when receiving a high level, and the normal black mode liquid crystal eyeglass remains in a light-blocking state when receiving a low level.

The normal white mode liquid crystal eyeglass is switched into a light-blocking state when receiving a high level and the normal white mode liquid crystal eyeglass remains in a light-transmitting when receiving a low level.

Alternatively, the frequency adjusting unit 61 is used to adjust the frequency thereof based on a predetermined frequency or a received refreshing frequency of the display, and generates and transmits a frequency signal to the frequency receiving unit based on the adjusted frequency. The frequency receiving unit 51 is used to transmit a control signal for switching between high and low levels to the voltage output unit 52 based on the received frequency signal. And the voltage output unit 52 supplies a high level or a low level to both of the normal white mode liquid crystal eyeglass 23 and the normal black mode liquid crystal eyeglass 22 concurrently through the voltage output terminal based on the received control signal.

Alternatively, the switching frequency between high and low levels is identical to the refreshing frequency of the display, in order to ensure a synchronization of an image seen through the 3D liquid crystal eyeglasses and an image displayed on the display.

The embodiments of the present invention provide a 3D glasses comprising liquid crystal eyeglasses in different modes, such that the control chip is only required to transmit one same signal to both of the liquid crystal eyeglasses at the same time to control the mode switching of the two liquid crystal eyeglasses. Therefore, the 3D glasses in accordance with the embodiments of the present invention substantially decreases the number of the signals required to be transmitted. Meanwhile, the control chip may receive the refreshing frequency of the display directly, or the operator may preset a frequency for the control chip, to decrease the manufacturing cost of the 3D glasses substantially.

### A Third Embodiment

The third embodiment of the present invention provides a control chip for a three-dimensional glasses with a normal black mode liquid crystal eyeglass and a normal white mode liquid crystal eyeglass, as shown in FIG. 5. The control chip comprises: a frequency receiving unit 51, for transmitting a control signal for switching between high and low levels to a voltage output unit based on a received signal; and the voltage output unit 52, for supplying a high level or a low level to the normal black mode liquid crystal eyeglass and the normal white mode liquid crystal eyeglass concurrently through a voltage output terminal based on the control signal.

Furthermore, as shown in FIG. 6, the control chip further comprises a frequency adjusting unit 61 that adjusts a frequency thereof based on a predetermined frequency or a current refreshing frequency of a display, and generates and transmits a signal based on the adjusted frequency to the frequency receiving unit 51.

Alternatively, the frequency adjusting unit 61 of the control chip adjusts the frequency thereof based on a predetermined frequency or a refreshing frequency of a display, and generates and transmits a frequency signal based on the adjusted frequency to the frequency receiving unit 51. The frequency receiving unit 51 is used to transmit a control signal for switching between high and low levels to the voltage output unit based on the received frequency signal.

The control chip in accordance with the embodiment of the present invention may apply to 3D glasses, thereby substantially decreasing the manufacturing cost of the 3D glasses.

The embodiments of the present invention provide a 3D glasses comprising liquid crystal eyeglasses in different modes, such that the control chip is only required to transmit one same signal to both of the liquid crystal eyeglasses at the same time to control the mode switching of the two liquid crystal eyeglasses. Therefore, the 3D glasses in accordance with the embodiments of the present invention substantially decreases the number of the signals required to be transmitted. Meanwhile, the 3D glasses may comprise a control chip, such control chip may receive a refreshing frequency of a display directly, or an operator may preset a frequency for the control chip, to decrease the manufacturing cost of the 3D glasses substantially.

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

1. A three-dimensional glasses, comprising:
a normal black mode liquid crystal eyeglass;
a normal white mode liquid crystal eyeglass; and
a control chip, connected to both of the normal black mode liquid crystal eyeglass and the normal white mode liquid crystal eyeglass, wherein a voltage output terminal of the control chip simultaneously supplies a high level or a low level to the normal black mode liquid crystal eyeglass and the normal white mode liquid crystal eyeglass based on a predetermined high and low level switching frequency.

2. The three-dimensional glasses in accordance with claim 1, wherein the control chip comprises: a frequency receiving unit and a voltage output unit, wherein the frequency receiving unit transmits a control signal for switching between high and low levels to the voltage output unit based on a received signal, and the voltage output unit simultaneously supplies a high level or a low level to the normal black mode liquid crystal eyeglass and the normal white mode liquid crystal eyeglass based on the control signal via the voltage output terminal.

3. The three-dimensional glasses in accordance with claim 2, wherein the three-dimensional glasses comprise a frequency transmitter that transmits the signal to the frequency receiving unit based on a predetermined frequency.

4. The three-dimensional glasses in accordance with claim 2, wherein the control chip further comprises a frequency adjusting unit that adjusts a frequency thereof based on a predetermined frequency or a current refreshing frequency of a display, and generates and transmits the signal based on the adjusted frequency to the frequency receiving unit.

5. The three-dimensional glasses in accordance with claim 3, wherein the predetermined frequency is identical to the refreshing frequency of the display.

6. The three-dimensional glasses in accordance with claim 2, wherein the signal received by the frequency receiving unit is a frequency signal.

7. The three-dimensional glasses in accordance with claim 3, wherein the signal transmitted by the frequency transmitter to the frequency receiving unit is a frequency signal.

8. The three-dimensional glasses in accordance with claim 4, wherein the signal transmitted by the frequency adjusting unit to the frequency receiving unit is a frequency signal.

9. A control chip for a three-dimensional glasses with a normal black mode liquid crystal eyeglass and a normal white mode liquid crystal eyeglass, comprising:
a frequency receiving unit, for transmitting a control signal for switching between high and low levels to a voltage output unit based on a received signal; and
a voltage output unit, for simultaneously supplying a high level or a low level to the normal black mode liquid crystal eyeglass or the normal white mode liquid crystal eyeglass through a voltage output terminal based on the control signal.

10. A control chip in accordance with claim 9, further comprising a frequency adjusting unit that adjusts a frequency thereof based on a predetermined frequency or a current refreshing frequency of a display, and generates and transmits the signal based on the adjusted frequency to the frequency receiving unit.

11. A control chip in accordance with claim 9, wherein the signal received by the frequency receiving unit is a frequency signal.

12. A control chip in accordance with claim 10, wherein the signal transmitted by the frequency adjusting unit to the frequency receiving unit is a frequency signal.

13. The three-dimensional glasses in accordance with claim 4, wherein the predetermined frequency is identical to the refreshing frequency of the display.
